(19) United States
(12) Patent Application Publication
(10) Pub. No.: US 2022/0324388 A1
(43) Pub. Date: Oct. 13, 2022

(54) VEHICLE GLASS PANEL WITH INSERT AND ASSOCIATED THERMAL CAMERA DEVICE

(71) Applicant: SAINT-GOBAIN GLASS FRANCE, COURBEVOIE (FR)

(72) Inventors: Vladimir OUSPENSKI, SAINT-PIERRE-LES-NEMOURS (FR); Keihann YAVARI, MARGNY-LES-COMPIEGNE (FR)

(21) Appl. No.: 17/640,703

(22) PCT Filed: Sep. 2, 2020
(86) PCT No.: PCT/EP2020/074491

§ 371 Date: Mar. 4, 2022

(30) Foreign Application Priority Data
Sep. 6, 2019 (FR) FR1909833

(51) Int. Cl. B60R 1/30; B60R 11/04; B60J 1/00; B60J 1/02

(52) U.S. Cl. CPC B60R 1/30; B60R 11/04; B60J 1/001; B60J 1/02; B60R 2011/0026

(57) ABSTRACT

A vehicle glazing includes, in a peripheral zone, a traversing hole including an insert made of a material having a crystalline structure which is transparent in a range A of wavelengths in the infrared spectrum of at least from 9.5 μm to 10.5μm and the material of the insert is transparent in the visible region at a reference wavelength of between 500 nm and 600 nm.

The invention relates to a glazing, in particular a windshield, in a motor vehicle, train or aircraft, in combination with a thermal camera. The invention also describes a device combining said glazing and said thermal camera for such a display of information. Vehicle glazings and the associated technology are constantly evolving, in particular in order to improve safety.

In particular, the patent GB 2 271 139 provides a windshield comprising a laminated glazing with, in a central part and close to the upper longitudinal edge, an opening filled by an insert made of material which is highly transparent to thermal infrared radiation, more specifically made of zinc sulfide (ZnS) with a transmission of at least 50% from 5 to 15 μm. A dedicated camera, coupled to a screen visible to the driver, is in the passenger compartment opposite the insert. The hole is circular and the insert is a disk adhesively bonded to the walls of the hole.

In terms of manufacture, the hole is manufactured before passing the windshield glass through an autoclave.

Such a windshield is not sufficiently reliable. The invention is targeted at overcoming this disadvantage.

More specifically, the present invention relates to a vehicle glazing (in particular laminated and/or bent), in particular of a motor vehicle (car, truck, public transportation: bus, and the like) or of a rail vehicle (especially having a maximum speed of at most 90 km/h or of at most 70 km/h, especially subways, streetcars), especially a windshield, or also a rear window, a side window (with a subcentimetric thickness E1 in particular of at most 5 mm for an automobile windshield), which glazing has an external main face (referred to as F1) directed toward the outside (of the vehicle)and an internal (innermost) main face on the passenger compartment side (referred to as F4 if laminated glazing or referred to as F2)

and which glazing comprises, in a peripheral zone (preferably at the upper longitudinal edge and/or in a central region), a traversing hole between the internal face and the external face, which hole is delimited by a side wall of the glazing, in particular an emerging hole forming a peripheral notch or a closed hole (surrounded by the wall), especially the hole with an equivalent diameter preferably of at least 5 mm, and is better still of at most 5 cm or 3 cm (with a constant equivalent diameter or a wider equivalent diameter on the interior face than on the exterior face), in particular with a convex cross section which is especially circular or oval or elliptical or also rectangular, square or hexagonal, which hole comprises (is filled by):
an insert (flat or bent, with an exterior face flush with or set back from the external face F1, indeed even also with an interior face going beyond, flush with or set back from the internal face F2 or respectively F4, if a laminated glazing) made of a material transparent in a range A of wavelengths in the infrared radiation spectrum, which insert has a given thickness E0, in particular a subcentimetric thickness, which can be greater than E1,
and preferably, between the insert and the side wall, means for fixing the insert (and also preferably forleaktightnessto liquid water, indeed even water vapor), in particular in the form of a ring made of organic (or hybrid organic/inorganic) and/or flexible polymer material, for example polycarbonate.

According to the invention, the range A extends from 9.5 μm to 10.5 μm, preferably from 8 μm to 12 μm or 13 μm, preferably with a light transmission or more specifically an infrared optical transmission of at least 50% and better still of at least 60%, 65% or 70% in this range A.

According to the invention, in addition, the material of the insert (distinct from a glass) is having a crystalline structure, preferably with a cubic crystallography, is transparent in the visible region at a reference wavelength of between 500 nm and 600 nm and even from 540 nm or 550 nm to 600 nm, better still in a range B from 550 nm to 600 nm, preferably with a light transmission of at least 25% and better still of at least 30% or even better still 40%, 60% in the range B.

Unlike the conventional ZnS, which is opaque in the visible spectrum, the material of the insert according to the invention is transparent in the visible region, which makes it possible:
to identify defects in the crystal in a simple way, thus limiting the reject rate
or else to pre-target the optical system (with a “thermal” camera sensitive in the reference wavelength and better still in the range B),
and even to use a camera or cameras sensitive in the visible spectrum (in the range B) and infrared spectrum (in the range A), for example on the basis of a division of a beam or by superimposing the detections (by capturing the infrared and visible images in parallel, and the like), this being done in order to improve the identification and classification of objects in the optical field.

It is possible to use a single lens in combination with optical sensors and infrared detectors in the range A or a first lens in combination with optical sensors in the reference wavelength and better still the range B and a second lens (made of germanium, and the like) in combination with infrared detectors in the range A.

The light transmission is measured for the reference wavelength or better still for the range B with a spectrophotometer, such as the Perkin-Elmer Lambda-35. The light transmission can be measured according to the standard ISO 9050:2003 using illuminant D65 and can be the total transmission (in particular integrated over the visible region and weighted by the curve of sensitivity of the human eye), taking into account both direct transmission and possible diffuse transmission, the measurement being carried out, for example, using a spectrophotometer equipped with an integrating sphere, the measurement at a given thickness subsequently being converted, if appropriate, to the reference thickness of 4 mm according to the standard ISO 9050:2003. The infrared optical transmission is measured for the range A by a Fourier spectrometer, such as the BrukerVertex-70.

Advantageously, the material of the insert exhibits:
an infrared optical transmission of at least 50% and better still of at least 60%, 65% or 70% in the range A, in particular a variation in infrared optical transmission of at most 5% or 3% or 2% (flat spectrum) in the range A,
and a light transmission of at least 25% and better still of at least 30% or also 40%, 60% in the range B, in particular a variation in light transmission of at most 5% or 2% (flat spectrum) in the range B.

The material can even be transparent from the start of the range B up to the end of the range A, and even preferably with a variation in transmission of at most 8% or 5% (flat spectrum) over this entire range of wavelengths.

For more safety, preferably, the modulus of rupture of the insert is greater than 20 MPa and even than 40 MPa.

Preferably, the equivalent diameter of the hole (constant or variable in thickness) and the equivalent diameter of the insert (constant or variable in thickness) are each at most 5 cm and even at most 3 cm, in particular of geometrical shape, preferably with a convex cross section which is in particular circular or oval or elliptical or also rectangular, square or hexagonal.

A hole (and insert) size which is too high can damage the mechanical strength of a glazing (windshield, and the like), with consequences forthe safety of passengers. Furthermore, the diameter of the insert is preferably at least 5 mm.

Preferably, the insert is not or only slightly hygroscopic, in particularwith a solubility value at 20° C. of at most 0.2 g in 100 ml of water.

For more transparency, the thickness EO of the insert can be less than or equal to 10 mm.

The material of the insert preferably exhibits a coefficient of absorption in the range A of at most 10⁻⁵cm⁻¹ and even of at most 10⁻³cm⁻¹ over the range A.

Preferably, the material of the insert exhibits a purity (by weight) of at least 99.99% or also of at least 99.995% and better still 99.999% and/or is devoid of inclusions (and/or of crystal defects) with a size of greater than 20 μm or even than 12 μm or 10 μm.

The insert is, for example, colorless or tinted (while remaining transparent), in particular yellow or orange.

The insert can be bent.

The material of the insert can be polished (exterior and interior face).

The material of the insert is preferably of cubic crystallography.

Advantageously, the material of the insert according to the invention is a polycrystalline material easier to manufacture than a single crystal.

Advantageously, the material of the insert according to the invention is chosen from a following material (preferably polycrystalline material), in particular obtained by chemical vapor deposition:
a zinc compound comprising selenium and/or sulfur or
a compound comprising barium fluoride
indeed even a compound comprising thallium bromide-iodide, such as that of KRS-5 (Thallium Bromide-Iodide) type, and in particular the material of the insert is chosen from:
a compound comprising a multispectral zinc sulfide, especially obtained after hot isostatic pressing (treatment by an isostatic press under the temperature preferably of at least800° C.), in particular including selenium, such as ZnSₓSe₁₋ₓ with x preferably of at least 0.97, better still of at least 0.99 and even better still of at least 0.998
a compound comprising azinc selenide, especially ZnSe, in particular including sulfur, such as ZnSe_{y}S_{1-y} with y of at least 0.97, better still of at least 0.99 and even better still at least 0.998
a compound comprising barium fluoride, in particular including calcium and/or strontium, in particular Ba₁₋ᵢ₋ᵢ₋ⱼCaSrⱼF₂ with i+j strictly less than 1, i and j each preferably of at most 0.25, better still of at most 0.03 or even better still of at most 0.005 or also Ba₁₋ᵢCaᵢF₂ with i strictly less than 1 and preferably of at most 0.25, better still of at most 0.03 or even better still of at most 0.005, especially BaF_{2.}

Zinc sulfide with a multispectral (MS) grade is a recent material. It can be polycrystalline and obtained by carrying out (in particular after formation by chemical vapor deposition CVD starting from zinc vapor and H₂S gas) a hot isostatic pressing (HIP). This appears to suppress defects in the crystal lattice, in particular to remove hexagonal phase crystallites by converting them into the cubic main phase, to reduce the volumes of pores and to homogenize the stoichiometry to thus attain the transparency in the visible region. Its structure is micro(poly)cristalline, comprising grains generally of 10 to 50 μm.

As indicated in the paper “Recrystallization Behavior of Zinc Chalcogenides during Hot Isostatic Pressing”, E. M. Gavrishchuk et al., Inorganics Materials, Vol. 50, No. 3, 2014, the HIP can be in an argon atmosphere between 810° C. and 1200° C. and under a pressure of 89 to 200 MPa for a period of time of 1 to 22 h.

The transmission of the multispectral zinc sulfide can be broad spectrum with a flat spectrum. The transmission is in particular greater than 60% from 0.5 μm to 10 μm.

Multispectral zinc sulfide is chemically inert, (virtually) non hygroscopic with a solubility value at 20° C. of less than 0.005 g in 100 ml of water.

The refractive index of multispectral ZnS is, for example, between 2.1 and 2.3 in the range A and, in the visible region, between 2.3 and 2.6.

Multispectral (in particular polycrystalline) zinc sulfide is admittedly generally less hard than conventional (monospectral) zinc sulfide but this remains acceptable in the light of the abovementioned optical advantages.

The modulus of rupture of the multispectral zinc sulfide insert can be greater than 60 or 65 MPa.

Multispectral zinc sulfide is generally more resistant than zinc selenide (and less resistant than conventional zinc sulfide).

The multispectral zinc sulfide single crystal exists but is more difficult to synthesize (in particular obtained by the Bridgman method of recrystallization under pressure and at high temperature). An example of the manufacture of the multispectral zinc sulfide single crystal is given in the publication by Gavrishchuk et al., J. Crystal Growth, 457, 2017, pp. 275-281.

Multispectral and preferably polycrystalline zinc sulfide is advantageous in the light of its combination of chemical resistance, optical and mechanical properties.

The best known polycrystalline multispectral zinc sulfide is Cleartran™.

Mention may be made of the multispectral ZnS product sold by II-VI or Crystaltechno Ltd.

Preferably, the multispectral and preferably polycrystalline zinc sulfide (ZnSe and more broadly ZnSₓSe₁₋ₓ) exhibits a purity (by weight) of at least 99.99% or also of at least 99.995% and better still 99.999% and/or is devoid of inclusions (and/or of crystal defects) with a size of greater than 20 μm or even than 12 μm or 10 μm.

Zinc selenide is less absorbent than multispectral zinc sulfide in the range B. Polycrystalline zinc selenide can also be obtained by CVD starting from zinc vapor and H₂Se gas. The zinc selenide single crystal exists but is more difficult to synthesize (in particular obtained by the Bridgman method under high pressure).

Zinc selenide is chemically inert, (virtually) nonhygroscopic, in particular with a solubility value at 20° C. of less than 0.005 g in 100 ml of water.

The transmission of (in particular polycrystalline) zinc selenide is broad spectrum and the spectrum is particularly flat. The transmission of (in particular polycrystalline) zinc selenide can be greater than 70% from 0.5 μm to 10 μm.

The modulus of rupture of the (in particular polycrystalline) zinc selenide insert is greater than 50 or 55 MPa.

The size of polycrystalline zinc selenide grains can be between 50 and 70 μm.

Mention may be made, as vendors of polycrystalline zinc selenide, of Hellma, II-VI or Crystaltechno Ltd.

An example of ZnSe_{y}S_{1-y} single crystal predominantly made of zinc selenide is described in the publication by Kozielski et al., Journal of Crystal Growth, 30, 1975, pp. 86-92. Preferably, the preferably polycrystalline zinc selenide (ZnSe_{y}S_{1-y} and in particular ZnSe) exhibits a purity (by weight) of at least 99.99% or also of at least 99.995% and better still 99.999% and/or is devoid of inclusions (and/or of crystal defects) with a size of greater than 20 μm or even than 12 μm or 10 μm.

The barium fluoride can be a single crystal obtained, for example, by the Bridgman-Stockbarger technique.

Advantageously, the barium fluoride can be polycrystalline (ceramic) and obtained with the method of synthesis starting from barium fluoride single crystals which makes it possible to increase the mechanical strength (to limit the splitting of single crystals because of cleavage). An example of the manufacture of ceramic barium fluoride is given in the publication by Fedorov et al., Inorganic Materials, 50, 2014, pp. 738-744.

Barium fluoride is weakly hygroscopic, in particular with a solubility value at 20° C. of less than 0.2 g in 100 ml of water. It is preferred with an equivalent diameter of at most 1 cm, as a precaution. The modulus of rupture of the barium fluoride insert can be greater than 25 MPa.

The transmission of the barium fluoride can be broad spectrum with a flat spectrum The transmission of the barium fluoride can be greater than 80% from 0.5 μm to 10 μm. Mention may be made, as barium fluoride single crystal, of the product sold by Hellma or Crystaltechno Ltd.

Preferably, the preferably polycrystalline barium fluoride (Ba₁₋ᵢ₋ⱼCaᵢSrⱼF₂or also BaCaᵢF₂ and in particular BaF₂) exhibits a purity (by weight) of at least 99.99% or also of at least 99.995% and better still 99.999% and/or is devoid of inclusions (and/or of crystal defects) with a size of greater than 20 μm or even than 12 μm or 10 μm.

Preferably, for more stability, as described in the publication by Duvel et al., Solid State Sciences, 83, 2018, pp. 188-191, i and j are low; in particular, i is of at most 0.03 and j is of at most 0.03 and even better still i is of at most 0.005 and j is of at most 0.005.

Advantageously, in order to improve the mechanical strength, as the insert comprises an exterior face and an interior face, it comprises a mechanical and/or chemical protective layer on the exterior face and optionally on the interior face.

The mechanical and/or chemical protective layer (preferably a monolayer or multilayer coating) can be chosen from at least one of the following layers:
a layer comprising a zinc sulfide (in particular ZnS), especially on a ZnSₓSe₁₋ₓ, in particular ZnSe, insert, for mechanical protection,
a diamond layer, preferably an amorphous diamond layer, for its properties of adhesion to the crystal of the insert, in particular with a thickness of at least 10 nm or 20 nm and preferably from 50 nm to 300 nm and even of at most 100 nm,
a DLC (diamond-like carbon) layer, that is to say a layer based on carbon of diamond type, preferably amorphous diamond type, in particular with a thickness of at least 10 nm or 20 nm and preferably from 50 nm to 300 nm and even of at most 100 nm.

The addition of a sufficiently thin layer of ZnS to ZnSe does not damage the transmission and guarantees a resistance to erosion similar to bulk ZnS. An example of a product is Tuftran™ from Rohm & Haas.

For example, the material, such as ZnSₓSe₁₋ₓ (including ZnS), can be coated with a ZnS layer in order to protect it from acids and other specific solvents, such as methanol, and the like.

Alternatively to ZnS, it is thus possible to deposit, for example by chemical vapor deposition (in particular PECVD) or physical vapor deposition (PVD), a diamond layer (or a DLC layer) without damaging the transmission and while guaranteeing an even greater resistance to erosion. An example of manufacture is described in the publication by Osipkov et al., IOP Conf. Ser. Materials Science and Engineering, 74 (2015), 012013.

The glazing according to the invention can be a laminated glazing, in particular a (road, especially automobile) vehicle windshield, which especially is bent, comprising a first glass sheet with said internal main face, referred to as F1, and an opposite main face (referred to as F2) and a second glass sheet with said external main face, referred to as F4, on the interior side of the passenger compartment (and the opposite main face F3), the first and second glass sheets being connected by a lamination interlayer, in particular acoustic and/or tinted, made of a polymer material, in particular one which is organic (in particular thermoplastic).

In particular, the laminated glazing comprises:
a first, optionally clear, extra-clear or tinted, in particular gray or green, preferably bent, glass sheet forming an exterior glazing, with first and second main faces respectively referred to as face F1 and face F2, if automotive vehicle with a thickness preferably of at most 2.5 mm, even of at most 2 mm — in particular 1.9 mm, 1.8 mm, 1.6 mm and 1.4 mm — or even of at most 1.3 mm or of at most 1 mm,
an optionally clear, extra-clear or tinted, in particular gray or green, lamination interlayer made of, preferably thermoplastic, polymeric material and better still made of polyvinylbutyral (PVB), preferably, if automotive vehicle, with a thickness of at most 1.8 mm, better still of at most 1.2 mm and even of at most 0.9 mm (and better still of at least 0.3 mm and even of at least 0.6 mm), in particular set back from the edge face of the first glazing by at most 2 mm and set back from the edge face of a second glazing by at most 2 mm, the lamination interlayer optionally having a cross section which decreases in wedge shape from the top toward the bottom of the laminated glazing (in particular a windshield),
a second glazing, made of mineral glass, which preferably is bent and preferably is clear or extra-clear, indeed even tinted, forming an interior glazing, with third and fourth main faces, if automotive vehicle with a thickness preferably less than that of the first glazing, even of at most 2 mm — in particular 1.9 mm, 1.8 mm, 1.6 mm and 1.4 mm — or even of at most 1.3 mm or of at most 1 mm, the thickness of the first and second glazings preferably being strictly less than 4 mm, even than 3.7 mm.

The interior and/or exterior glass can be neutral (without coloration) or (slightly) tinted, in particular gray or green, such as the TSA glass from Saint-Gobain Glass. The interior and/or exterior glass may have undergone a chemical or heat treatment of the hardening or annealing type or a tempering (in particular for better mechanical strength) or be semitempered.

Without departing fromthe scope of the invention, the interlayer can, of course, comprise several sheets made of thermoplastic of different natures, for example of different hardnesses in order to provide an acoustic function, such as, for example, described in the publication US 6 132 882, in particular a set of PVB sheets of different hardnesses. Likewise, one of the glass sheets may be thinned with respect to the thicknesses conventionally used.

The interlayer can, according to the invention, exhibit a wedge shape, in particular for the purpose of an HUD (head-up display) application. Furthermore, one of the sheets of the interlayer can be tinted in its bulk.

Mention may be made, as ordinary lamination interlayer, in addition to PVB, of flexible used polyurethane PU, a plasticizer-free thermoplastic, such as ethylene/vinyl acetate (EVA) copolymer, an ionomer resin. These plastics have, for example, a thickness between 0.2 mm and 1.1 mm, in particular between 0.3 and 0.7 mm.

The lamination interlayer can comprise another functional plastic film (transparent, clear or tinted), for example a film made of poly(ethylene terephthalate) PET carrying an electrically conductive athermal layer, and the like; for example, there is PVB/functional film/PVB between the faces F2 and F3.

The transparent plastic film can have a thickness of between 10 and 100 μm. The transparent plastic film can more broadly be made of polyamide, polyester, polyolefin (PE: polyethylene, PP: polypropylene), polystyrene, polyvinyl chloride (PVC), polyethylene terephthalate (PET), polymethyl methacrylate (PM MA) or polycarbonate (PC). A clear film is preferred, in particular PET.

Use may be made, as this, of, for example, a clear coated PET film, for example XIR from Eastman, a coextruded PET/PMMA film, for example of the SRF 3M®type, but also numerous other films (for example made of PC, PE, PEN, PMMA, PVC), which are visually as transparent as possible and which are not modified, in the autoclave, as regards their surface and their consistency.

In order to limit heating in the passenger compartment or to limit the use of air conditioning, one of the glass sheets at least (preferably the exterior glass) is tinted, and the laminated glazing can also comprise a layer which reflects or absorbs solar radiation, preferably on face F4 or on face F2 or F3, in particular a transparent electrically conductive oxide layer referred to as TCO layer (on face F4) or even a stack of thin layers comprising at least one TCO layer, or stacks of thin layers comprising at least one silver layer (on F2 or F3), the or each silver layer being positioned between dielectric layers. It is possible to simultaneously have a (silver-containing) layer on face F2 and/or F3 and a TCO layer on face F4.

The TCO layer (layer of a transparent electrically conductive oxide) is preferably a layer of fluorine-doped tin oxide (SnO₂:F) or a layer of mixed indium tin oxide (ITO).

Naturally, the most desired application is for the glazing to be a windshield of a road vehicle (automobile) or even a (moderate speed) rail vehicle.

The glazing according to the invention can comprise at least one first glass sheet comprising, on a main face, an opaque (masking) layer, in particular an enamel (black, and the like), along the edge of the traversing hole (so as to mask the camera(s), for example).

The laminated glazing according to the invention can comprise a first glass sheet comprising, on a main face (for example the face F2), an opaque (masking) layer, in particular an enamel (black, and the like), along the edge of the traversing hole (so as to mask the camera(s), for example) and/or a second glass sheet comprising, on a main face (for example the face F3 or F4), an opaque (masking) layer, in particular an enamel (black, and the like), along the edge of the traversing hole (so as to mask the camera(s), for example).

It is also possible to provide a masking layer on at least one of the main faces of the lamination interlayer, in particular PVB.

The invention also relates to a device which comprises:
the glazing as described above
a “thermal” camera (sensitive in the range A), positioned in the passenger compartment behind said glazing so as to receive radiation after crossing said insert, which thermal camera comprises a lens and a system for infrared detection in the range A, for example by microbolometry, in particular without cryogenic cooling, said camera optionally also being optical and comprising another sensor system (in the range B)
optionally an optical sensor (CCD or CMOS or the like) at the reference wavelength or better still in the range B, in particular which is incorporated in the thermal camera which is also optical or which is combined with a separate optical camera positioned in the passenger compartment behind said glazing so as to receive light radiation after crossing said insert.

Preference is given to infrared detection with a maximum sensitivity in the range A and even a slight sensitivity above 15 μm or 14 μm and below 7 μm or 6 μm.

Mention may be made, as example of thermal camera, of the product Atom®1024 from Lynred USA.

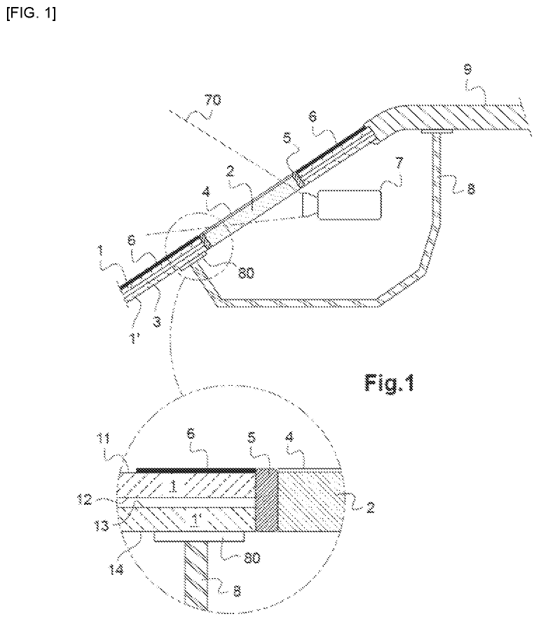

Certain advantageous but nonlimiting embodiments of the present invention are described below, which can, of course, be combined with one another, if appropriate. FIG. 1 diagrammatically represents a windshield 100 according to the invention, in section, with a thermal camera 7 placed behind the windshield facing a zone which is preferably located in the central and upper part of the windshield. In this zone, the camera is oriented with a certain angle with regard to the surface of the windshield (face F4). In particular, the infrared sensors and lens are oriented directly toward the zone for capturing images, along a direction close to the parallel with the ground, that is to say only slightly inclined toward the road. In other words, the camera is oriented toward the road along a low angle with a field 70 suitable for fulfilling its functions.

The windshield is conventional laminated glazing comprising:
an external glass sheet 1, preferably tinted, for example made of TSA glass and with a thickness of 2.1 mm, with an exterior face F1 and an interior face F2
and an internal glass sheet 1′, for example made of TSA (or clear or extra-clear) glass and with a thickness of 2.1 mm or even of 1.6 mm or even less, with an exterior face F3 and an interior face F4 on the passenger vehide side
the two glass sheets being connected to one another by an interlayer made of thermoplastic material 3, generally made of polyvinyl butyral (PVB), which is preferably clear, with a submillimetric thickness, optionally exhibiting a cross section which decreases in wedge shape from the top toward the bottom of the laminated glazing, for example a PVB (RC41 from Solutia or Eastman) with a thickness of approximately 0.76 mm, or, in an alternative form, if necessary, an acoustic (three-layer or four-layer) PVB, for example with a thickness of approximately 0.81 mm, for example an interlayer made of three PVB sheets.

In a conventional and well-known way, the windshield is obtained by hot lamination of the elements 1, 2 and 3.

The windshield 100 comprises, on the exterior face 11, for example (or preferably on F2 and/or on face F3 or F4), preferably an opaque coating, for example a black coating, 6, such as a layer of black lacquer or enamel, over the entire surface of the glazing positioned facing the device incorporating the thermal camera (thus, over the entire circumference of the hole), including its housing 8 (plastic, metal, and the like), so as to hide the latter. The housing 8 can be adhesively bonded to the face F4 by an adhesive 80 and to the roof 9.

The opaque layer 6 can extend beyond the zone with the insert. Optionally, the (side) extension of the opaque layer forming a strip along the upper edge of the traversing hole in order for the windshield to have an opaque (black) strip along the upper longitudinal edge, indeed even an opaque (black) frame over the whole of the periphery.

According to the invention, in the peripheral zone opposite the camera, the windshield comprises a traversing hole between the internal face and the external face, which hole is delimited by a side wall 10 of the laminated glazing (glass 1/PVB 3/glass 1′), said traversing hole comprising:
an insert 2 made of a material having a crystalline structure which is transparent in a range A of wavelengths in the infrared region which ranges at least from 9.5 μm to 10.5 μm and preferably from 8 μm to 12 μm, the insert having a given thickness E0 preferably of less than or equal to 10 mm,
between the insert and the side wall, means for fixing the insert, in particular in the form of a ring 5 made of flexible polymer material, the fixing means being in particular adhesively bonded to the side wall 10.

The material of the insert 2 is also transparent in the visible region at a reference wavelength of between 500 nm and 600 nm and better still is transparent in the visible region at least in a range B extending from 550 nm to 600 nm.

The material of the insert 2 exhibits an infrared (optical) transmission of at least 50% and better still of at least 65% in said range A and a light transmission of at least 30% and better still of at least 40% at the reference wavelength and better still in the range B.

The insert exhibits a modulus of rupture of greater than 20 MPa.

The equivalent diameter of the hole is of at most 5 cm and even of at most 3 cm; the equivalent diameter of the insert is of at most 5 cm and even of at most 3 cm.

The preferably polycrystalline material of the insert 2 is chosen from:
a zinc compound comprising selenium and/or sulfur or
a compound comprising barium fluoride.

In particular, the choice is made of:
a compound comprising a multispectral zinc sulfide, especially obtained after hot isostatic pressing, in particular including selenium, such as ZnSₓSe₁₋ₓ with x preferably of at least 0.97, especially multispectral ZnS
or a compound comprising a zinc selenide, especially ZnSe, in particular including sulfur, such as ZnSe_{y}S_{1-y} with y of at least 0.97
a compound comprising barium fluoride, in particular including calcium and/or strontium, in particular Ba₁₋ᵢ₋ⱼCaᵢSrᵢF₂ with i and j preferably of at most 0.25 or also Ba₁₋ᵢCaᵢF₂ with i preferably of at most 0.25, especially BaF_{2.}

The insert 2 comprises an exterior face and an interior face and it comprises in this instance preferably a mechanical and/or chemical protective layer 4 on the exterior face and optionally on the interior face. This is a coating chosen from a layer comprising a zinc sulfide, a diamond layer or a DLC layer.

Preferably, it is possible to choose a multispectral ZnS which is bare or covered with a zinc sulfide protective layer or a ZnSe covered with a zinc sulfide protective layer.

It is possible to add another camera which is optical recovering the light rays after crossing the insert 2 or simply to add optical sensors in the range B.

The traversing hole can alternatively be a notch, thus an emerging traversing hole preferably on the roof side.

The traversing hole (and the insert) can be in another region of the windshield or even in another glazing of the vehicle.

The glazing of the vehicle can be monolithic.

1. A vehicle glazing, with a thickness E1, the vehicle glazing comprising an external main face configured to be directed toward an outside of the vehicle and an internal main face configured to be oriented toward a passenger compartment side, and, in a peripheral zone, a traversing hole between the internal main face and the external main face, which traversing hole is delimited by a side wall of the vehicle glazing, said traversing hole comprising an insert made of material having a crystalline structure which is transparent in a range A of wavelengths in the infrared spectrum above 2.5 μm, the insert being of thickness E0,
wherein the range A extends at least from 9.5 μm to 10.5 μm and wherein said material of the insert is transparent in the visible region at a reference wavelength of between 500 nm and 600 nm.

2. The vehicle glazing as claimed in claim 1, wherein said material of the insert is transparent in the visible region in a range B extending from 550 nm to 600 nm.

3. The vehicle glazing as claimed in claim 2, wherein the material of the insert exhibits an infrared optical transmission of at least 50% in said range A and a light transmission of at least 30% at the reference wavelength and better still in the range B.

4. The vehicle glazing as claimed in claim 1, wherein the insert exhibits a modulus of rupture of greater than 20 MPa.

5. The vehicle glazing as claimed in claim 1, wherein an equivalent diameter of the traversing hole is of at most 5 cm.

6. The vehicle glazing as claimed in claim 1, wherein the material of the insert is polycrystalline.

7. The vehicle glazing as claimed in claim 1, wherein the material of the insert is chosen from:
a zinc compound comprising selenium and/or sulfur or
a compound comprising barium fluoride.

8. The vehicle glazing as claimed in claim 1, wherein the material of the insert is chosen from:
a compound comprising a multispectral zinc sulfide, especially obtained after hot isostatic pressing,
a compound comprising a zinc selenide,
a compound comprising barium fluoride

9. The vehicle glazing as claimed in claim 1, wherein the insert comprises an exterior face and an interior face and a mechanical and/or chemical protective layer on the exterior face and optionally on the interior face.

10. The vehicle glazing as claimed in claim 1, wherein the mechanical and/or chemical protective layer is chosen from: a layer comprising a zinc sulfide, a diamond layer and a DLC layer.

11. The vehicle glazing as claimed in claim 1, further comprising, between the insert and the side wall, means for fixing the insert.

12. The vehicle glazing as claimed in claim 1, wherein the vehicle glazing forms a laminated glazing the laminated glazing comprising a first glass sheet with said internal face and an opposite face and a second glass sheet with said external face on the side of the interior of the passenger compartment, the first and second glass sheets being connected by an acoustic and/or tinted lamination interlayer made of a polymer material.

13. The vehicle glazing as claimed in claim 1, further comprising at least one first glass sheet comprising, on a main face, an opaque layer along an edge of the traversing hole.

14. A device, comprising:
said glazing as claimed in claim 1
a thermal camera, positioned in the passenger compartment behind said glazing so as to receive radiation after crossing said insert, which thermal camera comprises a lens and a system for infrared detection in the range A,
optionally an optical sensor at the reference wavelength, which is incorporated in the thermal camera which is also optical or which is combined with a separate optical camera positioned in the passenger compartment behind said glazing so as to receive light radiation after crossing said insert.

15. The vehicle glazing as claimed in claim 1, wherein the vehicle glazing is an automotive vehicle or rail vehicle.

16. The vehicle glazing as claimed in claim 1, wherein the vehicle glazing is a windshield, a rear window or a side window.

17. The vehicle glazing as claimed in claim 1, wherein the range A extends at least from 8 μm to 12 μm.

18. The vehicle glazing as claimed in claim 3, wherein the material of the insert exhibits an infrared optical transmission of at least 70% in said range A and a light transmission of at least 40% at the reference wavelength and better still in the range B.

19. The vehicle glazing as claimed in claim 5, wherein an equivalent diameter of the insert is of at most 5 cm.

20. The vehicle glazing as claimed in claim 6, wherein the material of the insert is obtained by chemical vapor deposition and by hot isostatic pressing.
